(19) United States
(12) Patent Application Publication
(10) Pub. No.: US 2023/0214777 A1
(43) Pub. Date: Jul. 6, 2023

(54) RECRUITER-FACILITATED EMPLOYEE REFERRAL

(71) Applicant: Indeed Ireland Operations, Ltd., Dublin (IE)

(72) Inventors: Kshitij Jain, Washington, DC (US); Scott Garrett, Kingwood, TX (US)

(21) Appl. No.: 14/060,248

(22) Filed: Oct. 22, 2013

Related U.S. Application Data
(60) Provisional application No. 61/717,278, filed on Oct. 23, 2012.

(51) Int. Cl. G06Q 10/10; G06Q 50/00

(52) U.S. Cl. CPC G06Q 10/1053; G06Q 50/01

(57) ABSTRACT

In one embodiment, a recruiter-facilitated employee referral technique involves forming connections being between accounts of one or more employees of a company and a company account in an online social network. A recruiter interface is provided for receiving requirements for a job from a recruiter. A search may be performed of other accounts connected to accounts of the one or more employees based on the requirements. The search utilizes access provided in the online social network to the company account, and yields a list of targets representing job candidates for the job. A selection of a target from the list is received from the recruiter. An electronic message is sent to an employee who is connected to the selected target in the online social network, soliciting the employee to refer the selected target for the job. The electronic message may include a uniform resource locator (URL) to an online job posting.

### RELATED APPLICATION

The present application claims priority to U.S. Provisional Patent Application Ser. No. 61/717,278, filed on Oct. 23, 2012 by Jain et al., entitled “Recruiter-Employee Collaborative Referral Process for Mobile and Desktop”, the contents of which are incorporated by reference herein in their entirety.

### BACKGROUND

### Technical Field

The present disclosure relates generally to techniques for filling job openings, and more specifically to techniques for recruiter-facilitated employee referral.

### BACKGROUND INFORMATION

An employee referral is a process where an existing or previous employee (hereinafter referred to simply as an “employee”) of a company refers a friend, former co-worker, or other contact, to one or more job openings at the company he or she currently work at or has worked at. The employee may fill out one or more forms in the company's applicant tracking system (ATS), human resources information system (HRIS), or Candidate Relationship Management System (CRM) that describe the referred candidate. After the forms are filled out, a human resources (HR) representative of the company may contact the referred candidate, and set up interviews and other next steps with them. The employee may receive incentives (e.g., an employee referral bonus) for referring the candidate, if they are eventually hired. The incentives are intended to encourage employee referrals.

In many organizations, the employee referral is considered a preferred source of for new hires. Compared to other sources, employee referrals are typically more cost effective, provide candidates that better culturally match the company, have shorter times to hire, and have other desirable qualities. While incentives paid to employees are an expense, many companies are happy to incur this expense, as it provides a side-benefit of increasing employee morale and job satisfaction. Further, despite the incentives paid. The cost per hire from employee referrals is still generally lower than other traditional sources of hiring.

However, even though incentives (e.g., employee referral bonuses) are commonly provided, many companies do not receive sufficient numbers of employee referrals to meet their needs. Many employees simply do not refer, or refer only a minimal number of candidates for open jobs. Typically, recruiters receive many less employee referrals than they want. In a recent study by Mobolt, Inc. of 150+ in-house recruiters of Fortune 1000 companies, 78% of all the companies reported they receive less than 30% of hires from employee referrals and 70% reported they desired the percentage of hires from employee referrals to be 50% or more. The existing low referral rate, and the gap between the supply and demand of these types of referrals, may be attributed to problems inherent to traditional employee referral processes. Foremost among these problems is that, in traditional processes, the onus is on the employee to drive the process. The placement of the onus is very significant issue. The employee typically has to locate a job opening at the company (e.g., using the company's Intranet). The employee also has to locate a friend, former co-worker, or other contact that has a skillset and would be a good match for the job. The employee typically then has to fill out forms in the company's ATS or HR information system that describe the candidate. These forms are generally quite detailed, often similar to a full job application. It may take the employee 30 minutes to 2 hours, and sometimes even longer, to fill out the required forms. Given the many demands on an employee's time, many employees simply do not take time out of their day to locate jobs, locate candidates, and fill out forms, even though an incentive may be offered. They typically consider the expenditure to time too great given the uncertainty of reward (e.g., as referral bonuses are typically only paid if the candidate is eventually hired).

This problem may be self-reinforcing. Since the employee referral process is long and burdensome, employees tend to refer fewer job candidates. This results in fewer new hires from employee referrals, and fewer employee referral bonuses being issued. The low number of referral bonuses results in lower motivation among employees to refer, making them less likely to suffer through the long and burdensome employee referral process, which results in even fewer new hires from employee referrals, and even fewer referral bonuses. This cycle generally repeats, reinforcing itself, such that referral rates trend lower and lower.

The problem may also be compounded by technological limitations. Traditional employee referral processes often has to be performed using an employee's office computer (e.g., their desktop or laptop computer). This requirement generally stems from a combination of issues. Some companies do not allow remote Intranet access and, therefore, information posted on the Intranet may not be accessible outside the office. Some companies do not provide mobile-friendly interfaces for the company's ATS or HR information systems. Similarly, some companies do not provide other types of applications or tools to accommodate mobile users. As a result, even if an employee has a mobile device (i.e. a smartphone, tablet computer or other Internet-connected electronic device designed to be transported on one's person), they are typically prevented from using it to make employee referrals. As a result, even if some employees have available time while mobile (e.g., while commuting to or from the office) they may be prevented from using this time to make employee referrals.

Further, some companies hinder use of even office computers in a referral process. Some companies block access to online social networks (e.g., the Linkedin® social network, the Facebook® social network, the Google+® network, etc.) on company computers, removing access to a tool that may be useful. Further, some companies have employee referral programs that are email based, or exist in a way that does not integrate with their ATS or CRM systems. The above discussed study by Mobolt, Inc. found that 62% of surveyed companies had this issue. In such cases, an employee may never know if a referral is eventually hired, and may fail to receive incentives if this information is not properly tracked.

What is needed is an improved technique for facilitating employee referrals of job candidates, that may address these and/or other problems of traditional employee referral processes.

### SUMMARY

In one example embodiment, a technique is provided for recruiter-facilitated employee referral, that leverages the capabilities of an online social network. Employees of a company each install an employee referral application (app) on an electronic device (e.g., their mobile device), or access an employee referral web page (e.g., a Hypertext Markup Language version 5 (HTML5) page) within a web browser of the electronic device. As part of installing the app or accessing the web page, the employee authorizes a connection to be made in an online social network (e.g., the Linkedin® social network, the Facebook® social network, the Google+® network, etc.) between their account and a company-affiliated account (herein referred to simply as the “company account”). As a result of each employee authorizing a connection, the employees' accounts become connected to (e.g., 1^{st} level connections of) the company account.

A recruiter interface (e.g., an HTML5 page) is provided on an electronic device for professional job recruiters, human resources staff or other persons tasked with filling open job positions (hereinafter collectively referred to simply as “recruiters”). The recruiter interface effectively proxies recruiter actions through the company account, allowing the recruiter to drive much of the employee referral process. The recruiter interface includes an employee base filtering tool, using which the recruiter may define a custom group of employees (herein referred to as an “employee base”) from among the employees that have become connected to (e.g., 1^{st} level connections of) the company account. The recruiter interface further includes a candidate search tool, using which the recruiter may enter requirements of a candidate for a job. The candidate search tool causes a search to be performed of others in the online social network whose accounts are connected to the accounts of employees in the employee base, utilizing access provided in the online social network to the company account. By virtue of the company account's connections to the employees' accounts, the company account is generally permitted to search connections of connected accounts (e.g., 2nd level connections), under rules commonly imposed in online social networks.

The search may yield a list of targets representing job candidates meeting the entered requirements, which is displayed in the recruiter interface. In response to selection of a particular target, the recruiter interface may display a list of employees whose accounts in the online social network are connected to that target. In response to selection of one or more connected employees from this list, the recruiter interface may cause an electronic message (e.g., an email, text message, etc.) to be sent to each selected connected employee, requesting them to refer the selected target for the job. The electronic message may ask the connected employee to contact the target, and solicit their interest in the job, leveraging any personal rapport the employee may have with the target. If the target is interested, the employee may be asked to provide them with information for applying for the job. In some cases, the information may include a uniform resource locator (URL) to an online job posting. In one implementation, the URL is encoded with a unique identifier associated with the connected employee, which may be used in tracking incentives (e.g., referral bonuses).

Such a recruiter-facilitated employee referral technique may increase employee referral rates. In contrast to traditional processes, it may shift part of the onus from the employee to the recruiter. The shifting of onus is a very significant improvement. The recruiter finds the job and finds the job candidates. The employee simply uses their personal rapport with the job candidate to contact them and solicit their interest in the job. Further, the recruiter-facilitated employee referral technique may better utilize mobile devices than traditional processes, enabling employees to complete their portion of a referral during downtime they may have while mobile (e.g., while commuting).

### BRIEF DESCRIPTION OF THE DRAWINGS

The Detailed Description below refers to the accompanying drawings of example embodiments, of which:

FIG. 1 is a block diagram of an example system for supporting recruiter-facilitated employee referral;

FIG. 2A is a flow diagram of an example sequence of steps for a first portion of an example recruiter-facilitated employee referral technique occurring on an employee's side;

FIG. 2B is a flow diagram of an example sequence of steps for a second portion of the example recruiter-facilitated employee referral technique occurring on an employee's side;

FIG. 3 is a flow diagram of an example sequence of steps for a portion of the example recruiter-facilitated employee referral technique occurring on a recruiter's side;

FIG. 4 is a screen shot of an example user interface for an example candidate search tool;

FIG. 5 is a diagram of example connections between a company account, employee accounts, and accounts of others that are connected to accounts of employees in an online social network;

FIG. 6 is a screen shot of an example list of targets that may be shown by a recruiter interface;

FIG. 7 is a screen shot of an example list of connected employees that may be shown by a recruiter interface; and

FIG. 8 is an example electronic message (in this example, an email) that may be sent to a selected connected employee requesting them to refer a selected target for a job.

### DETAILED DESCRIPTION

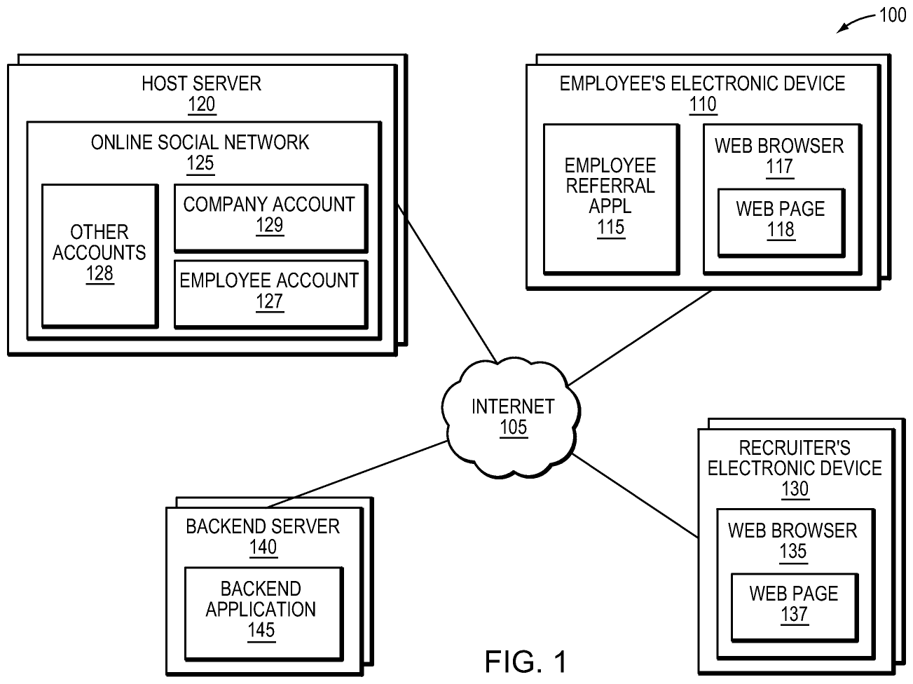

FIG. 1 is a block diagram of an example system 100 for supporting recruiter-facilitated employee referral. Employees of a company may each have an electronic device (e.g., a mobile device) 110. The electronic device 110 may includes a processor coupled to a memory that stores machine-executable instructions, and a network interface that couples the electronic device 100 to a network, such as the Internet 105. The machine-executable instructions may include instructions for an employee referral application (app) 115 installed by the employee on the electronic device 110 and/or a web browser 117 on the electronic device 110, through which the employee may access an employee referral web page (e.g., a Hypertext Markup Language version 5 (HTML5) page) 118.

The electronic device 110 may communicate through the Internet 105 with one or more hosting servers 120 that host an online social network 125 (e.g., the Linkedin® social network, the Facebook® social network, the Google+® network, etc.). Each hosting server may include a processor, a memory, a network interface, and other hardware that supports the online social network 125. Employees of the company may each have an account 127 within the online social network 125. The account may allow the employee to post a profile containing certain biographical information about themselves and make connections to the accounts of others 128. The company may also have a company-affiliated account (a company account) 129 within the online social network.

One or more electronic devices (e.g., desktop computers, laptop computers, tablets, etc.) 130 of recruiters (professional job recruiters, human resources staff or other persons tasked with filling open job positions) may also communicate through the Internet 105 with the one or more hosting servers 120. A recruiter's electronic device 130 may include a processor, memory, network interface and other hardware components, which operate in conjunction with software to provide a recruiter interface. In one implementation, the recruiter interface may be a web page (e.g., an HTML5 page) 137 displayed within a web browser 135 on the electronic device 130. The recruiter interface may include an employee base filtering tool and a candidate search tool, as discussed further below.

While certain tasks enabled by the recruiter interface may be executed on the recruiters electronic device 130, in some implementations, at least some tasks may be performed at one or more backend servers 140, accessible over the Internet 105. Each backend server 140 may include a processor, a memory, a network interface and other hardware that supports functions of a backend application 145. The backend application 145 may interoperate with the recruiter interface (e.g., web page 137) and with Application Program Interfaces (APIs) of the online social network 125.

Together, employees on their electronic devices (e.g., mobile devices) and recruiters using their electronic devices (e.g., desktop computers) may cooperate to refer job candidates, according to a recruiter-facilitated employee referral technique. In contrast to traditional employee referral processes, where the onus is on the employee to drive the process, the recruiter-facilitated employee referral technique may offload some of the onus to the recruiter, who is better suited for handling this responsibility. Thereby, operations are split between the employee's side and the recruiter's side. The recruiter may be responsible for finding a job and finding a relevant candidate. The employee may be responsible for contacting the job candidate and encouraging him or her to consider the job. By reducing the burden on employees, higher referral rates may be achieved than with traditional processes.

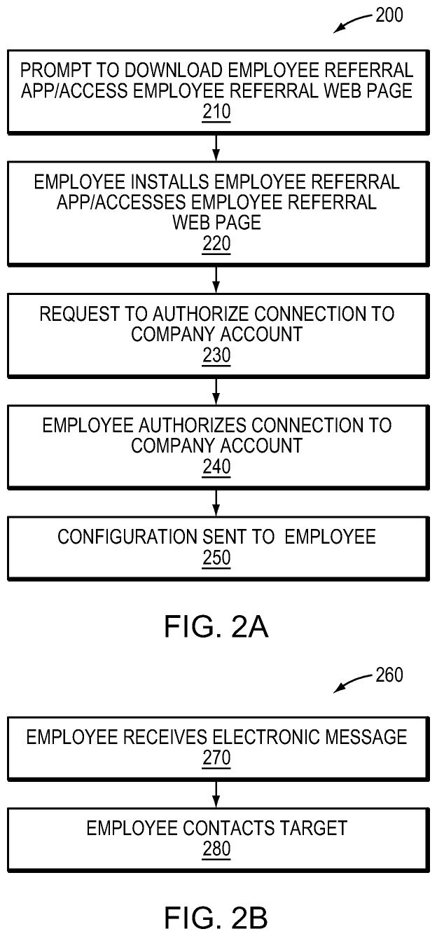

FIG. 2A is a flow diagram 200 of an example sequence of steps for a first portion of an example recruiter-facilitated employee referral technique occurring on an employee's side. While the steps 200 are explained from the perspective of a single employee, it should be understood that the steps may be applicable to each of the employees of the company. At step 210, the employee is prompted to download the employee referral app 115, or to access the employee referral web page 118. For example, the employee may receive a communication (e.g., an email, text message, etc.) on their electronic device 110 from the company's HR department that includes a link to download the employee referral app 115 or to navigate to the web page 118. The link may contain a unique identifier associated with the employee, for example, an indication of their employee identifier (id).

At step 220, the employee installs the employee referral application (app) on their electronic device 110, or accesses the employee referral web page 118 within the web browser 117 of their electronic device 110. If the link to download the app 115/access the web page 118 includes a unique identifier, the user may be automatically authenticated. If not, the user may, upon opening the app 115 or accessing the web page 118 for the first time, be prompted to manually enter authentication information, for example their employee id. The employee id may be compared to a database (for example, included in the backend application 140) to verify employment status.

At step 230, the employee is requested to authorize a connection to be made in the online social network 125 between their account 127 and the company account 129. The request may take the form of a terms and conditions (T&C) page presented during installation of the app 115 or first access to the web page 118. Alternatively, the request may take another form. At step 240, the employee authorizes the connection to be made in the online social network 125. For example, the user accepts the T&C page. As a result, the employee's account becomes connected to (e.g., a 1^{st} level connection of) the company account 129 in the online social network. At step 250, a confirmation is sent to the employee.

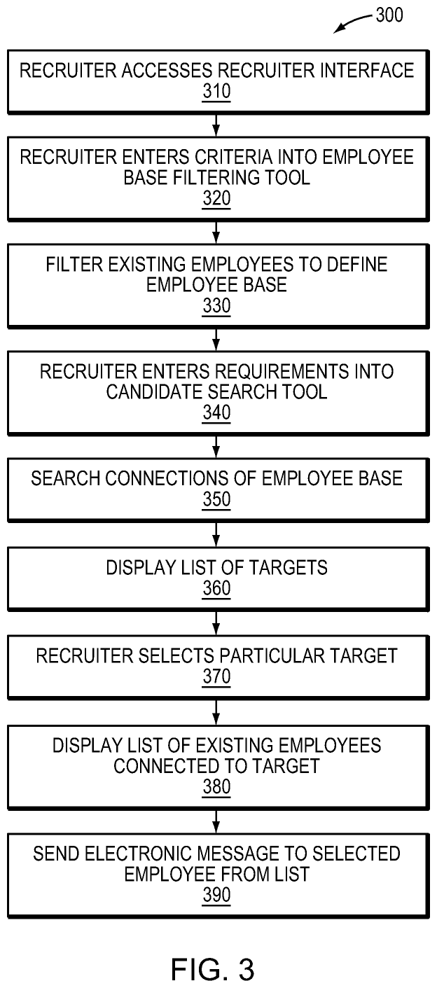

FIG. 3 is a flow diagram 300 of an example sequence of steps for a portion of the example recruiter-facilitated employee referral technique occurring on a recruiter's side. At step 310 the recruiter accesses a recruiter interface on their electronic device 130, for example, by navigating to the web page 137 within the web browser 135. In general, the recruiter interface may effectively proxy recruiter actions through the company account 129 to utilize the access it is provided in the online social network 125. The recruiter may be prompted to enter credentials in order to gain access to functionality of recruiter interface.

At step 320, the recruiter enters criteria into an employee base filtering tool of the recruiter interface to define a custom group of employees (an “employee base”) from among the employees that have become connected to (e.g., 1^{st} level connections of) the company account. The employee base filtering tool may categorize employees based on keywords, company names, schools attended, location, industry, category, languages, experience (e.g., in years), management levels, and other types of filters. At step 330, the employees are filtered to define the employee base. The operation may be performed, at least in part, by the backend application 145, interacting with the APIs of the online social network 125. At step 340, the recruiter enter requirements of a candidate for a job into a candidate search tool of the recruiter interface.

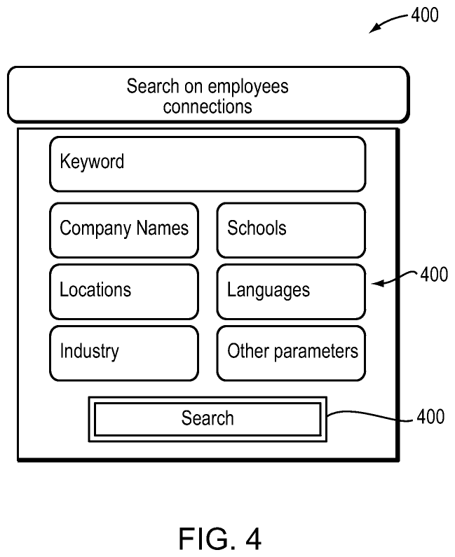

FIG. 4 is a screen shot of an example user interface 400 for an example candidate search tool. Fields 410 may be provided for searching the employee base using various parameters, including, keywords, company names, schools attended, locations, industry, and/or other parameters. A button or other interface element 420 may be provided to initiate a search using the parameters.

At step 350, a search may be performed of others in the online social network who are connected to employees in the employee base, using the entered parameters. The operation may be performed, at least in part, by the backend application 145, interacting with the APIs of the online social network 125. The search utilizes access provided in the online social network to the company account 129. By virtue of the company account's connections to the employees' accounts 127, the company account 129 is generally permitted to search their connections (e.g., since they are 2nd level connections of the company account), under rules commonly imposed in online social networks. The search may yield targets representing job candidates meeting the entered requirements.

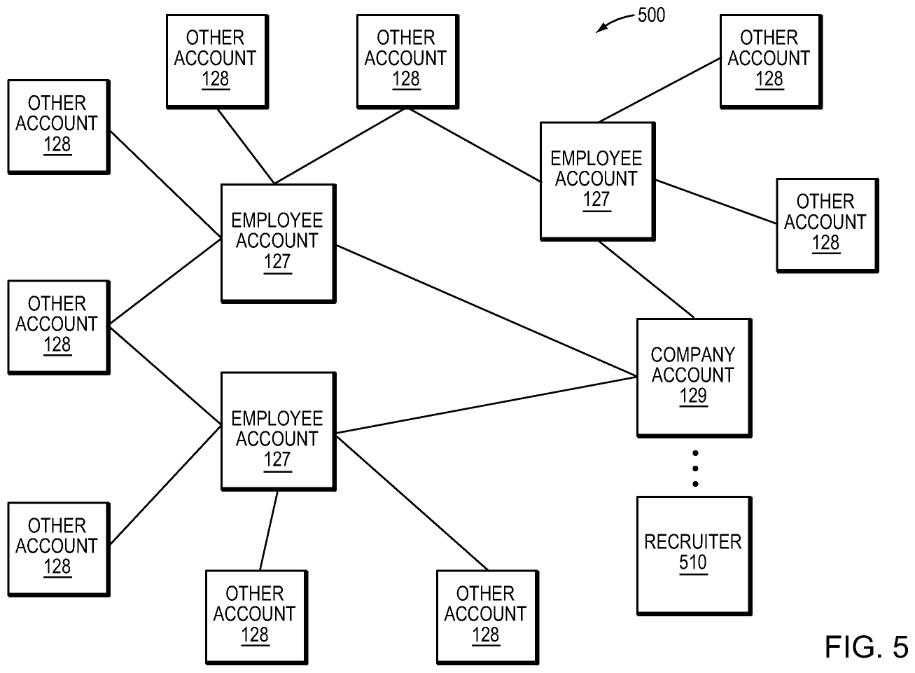

FIG. 5 is a diagram 500 of example connections between a company account 129, employee accounts 127, and accounts of others 128 that are connected to accounts of the employees in the online social network 125. While a small number of example accounts and connections are shown in FIG. 5, it should be understood that typical configurations may include a far greater number of accounts and connections. The company account 129 has 1^{st} level connections to the employee accounts 127. The employee accounts 127 have 1^{st} level connections to accounts of others 128. The company account 129 thereby has 2nd level connections to the accounts of others 128, which, under rules commonly imposed in online social networks, is typically sufficient to permit a search of their profiles.

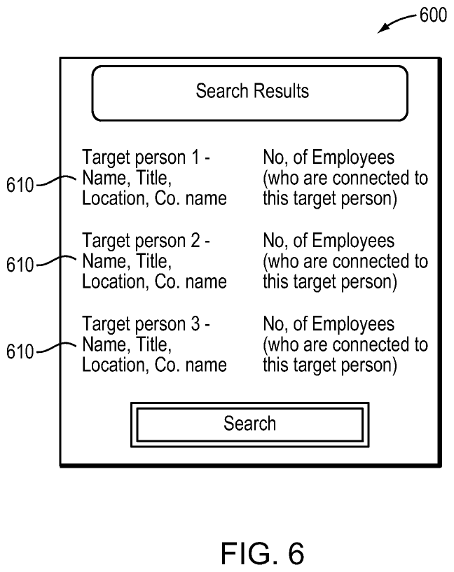

At step 360, a list of targets representing job candidates meeting the entered requirements is displayed to the recruiter in the recruiter interface. FIG. 6 is a screen shot of an example list of targets 600 that may be shown by the recruiter interface. For each target, an entry 610 may be shown that includes biographical information, such as the target's name, title, location, current company name, etc., and connection information, such as a number of employees whose accounts in the online social network 125 are connected to the target's account. Each entry may be selectable, to allow a recruiter to select a particular target.

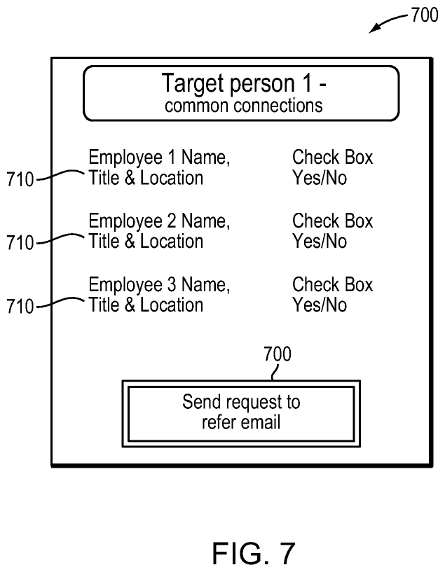

At step 370, a recruiter selects a particular target from the target list. At step 380, in response to the selection, a list of employees whose accounts in the online social network are connected to that target is displayed in the recruiter interface. FIG. 7 is a screen shot of an example list of connected employees 700 that may be shown by the recruiter interface. The connected employees may be considered “common connections”, i.e. individuals whose accounts are connected to both the company account and the target's account, and thereby “bridge the gap” between the two. For each connected employee, an entry 710 may be shown that permits selection of the connected employee. A button or other interface element 720 may be provided that, when activated, causes an electronic message (e.g., an email, text message, etc.) to be sent to the selected connected employee.

At step 390, the recruiter selects one or more connected employees from the list and sends them an electronic message. In some implementations, the electronic message may be an “in-app” message, such that it is received by, and viewed within, the employee referral app 115. In other implementations, the electronic message may be a sent within the online social network 125, using its messaging functionality, or via a traditional electronic messaging program, such that it is received and viewed separate from the employee referral app 115. The electronic message may ask the connected employee to contact the target, and solicit their interest in the job, leveraging any personal rapport the employee may have with the target.

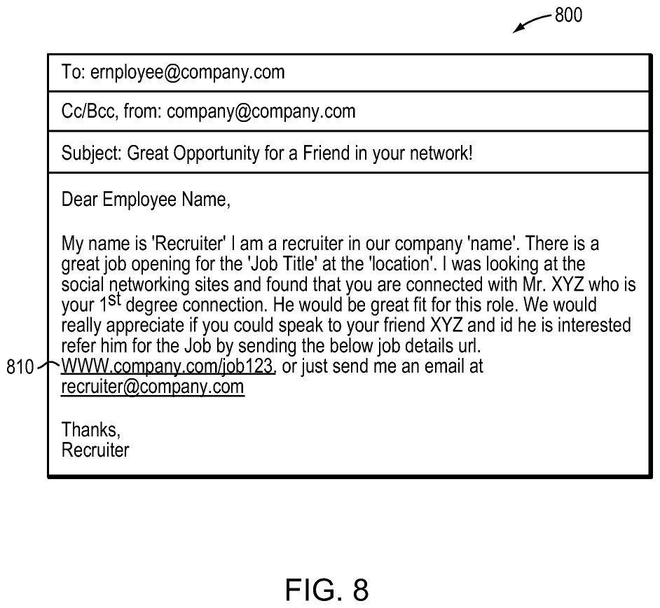

FIG. 8 is an example electronic message (in this example, an email) 800 that may be sent to a selected connected employee requesting them to refer the selected target for the job. The message may ask the employee to contact the target and determine their interest in the job, and if they are interested, provide them with information for applying for the job. In some cases the information may include a uniform resource locator (URL) 810 to an online job posting. In one implementation, the URL is encoded with a unique identifier associated with the connected employee, which may be used in tracking incentives (e.g., referral bonuses). Alternatively, the electronic message may include other information.

FIG. 2B is a flow diagram 260 of an example sequence of steps for a second portion of an example recruiter-facilitated employee referral technique occurring on an employee's side. At step 270, the employee receives an electronic message on their electronic device 110 asking them to contact a target and solicit their interest in a job. At step 280, the employee contacts the target, for example, using their electronic device 110, to determine their interest in the job. The employee may provide them with information for applying for the job, such as a URL to an online job posting. Alternatively, the employee may ask for permission from the target to enter their information into an ATS or HR information system of the company.

In summary, the above described recruiter-facilitated employee referral technique may improve upon traditional employee referral processes, achieving, among other benefits, higher referral rates. While various specific examples are described, it should be apparent that the technique may be implemented in other manners, which modify, add to, or remove aspects of these examples.

For instance, while the above examples involve employees of a company, it should be understood that the technique is not limited to commercial enterprises having paid workers. At least portions of the technique may be applicable to non-commercial organizations (e.g., an alumni organization) having unpaid members.

Likewise, while the above examples involve one company, the technique is not limited use within the boundaries of a single organization. At least portions of the technique may be applicable across company boundaries, with employees of one company referring targets to job openings at another company.

Similarly, of while reference is made above to being able to search profiles of 2^{nd} level connections, it should be understood that the technique is not limited to a particular degree of connectivity within an online social network. Depending on the rules of the online social network, the technique may be adapted for use with other degrees connectivity (e.g., 3rd level connections) or other types of associations within the network.

Further, the above described recruiter-facilitated employee referral technique may be applicable despite the particular terminology used in the particular online social network. For example, in the Facebook® social network, 2nd level connections may be referred to as “Friends of Friends.” The technique may be applicable readily applied to “Friends of Friends”, and levels of connectivity having a variety of different names.

Still further, while certain hardware and software are discussed above, it should be understood that the technique may be implemented using a variety of different hardware, software, and combination thereof. Electronic devices may include computer hardware of various types including desktop computers, laptop computers, tablets, smartphones, handhelds, and the like that execute programmable computer code to implement the apparatus and carry out the methods described. Such computer hardware may include processors, memory chips, programmable logic circuits, application specific integrated circuits, and/or other types of hardware components that support execution of software. Such software may include executable instructions that implement applications stored in a non-transitory computer-readable medium, such as a volatile or persistent memory device, a hard-disk, a compact disk (CD), etc. Combinations of software and hardware may be adapted to suit technological needs and environments.

What is claimed is:

1. A method for recruiter-facilitated employee referral of job candidates for a job, the method comprising:
executing, by a processor, a non-transitory program stored in a memory to cause a machine to perform:
for each of multiple employees of a company, receiving an authorization from the employee via an application installed on an electronic device authorizing an employee-authorized online social network connection to be made, in an online social network, between at least one online social network account of the employee and a company online social network account registered to the company, wherein the online social network is owned, hosted, and controlled by a third-party and accessible via the Internet, and wherein the at least one online social network account of the employee and the company online social network account are accounts with the online social network;
causing, within the online social network, a formation of the employee-authorized online social network connections between the at least one online social network account of each of the multiple employees and the company online social network account;
providing a recruiter interface, distinct from a company interface used by the company to access the company online social network account, to (i) enable an electronic device of a recruiter external to the company to, based on the employee-authorized online social network connections, use the company online social network account as a proxy to remotely access the at least one online social network account of each of the multiple employees;
receiving, from the electronic device of the recruiter using access made available to the company online social network account via the recruiter interface, filtering criteria corresponding to one or more categories of employee attributes of the multiple employees;
defining, according to the filtering criteria received from the electronic device of the recruiter via the recruiter interface, an employee base representing a sub-group of the multiple employees identified by searching through the at least one online social network account of each of the multiple employees based on similarities across the one or more categories;
receiving, from the electronic device of the recruiter using the access made available to the company online social network account via the recruiter interface, requirements for the job and instructions to perform an automated search, using a search tool available via the recruiter interface, within the online social network for accounts of persons having target online social network accounts connected to the at least one online social network account of any employee represented in the employee base;
performing, according to the instructions received from the electronic device of the recruiter via the recruiter interface, the automated search utilizing access to the target online social network accounts via the employee-authorized online social network connections to determine, from amongst the target online social network accounts, a list of job candidates meeting the requirements for the job;
receiving, from the electronic device of the recruiter, a selection of a job candidate from the list of job candidates for the job;
in response to the selection, determining one or more employees represented in the employee base whose at least one online social network account is connected to the target online social network account of the job candidate; and
sending, on behalf of the recruiter, an electronic message to the one or more employees, the electronic message soliciting and including a mechanism to allow each of the one or more employees to refer the job to the job candidate.

2. The method of claim 1, further comprising:
for each of the multiple employees, providing the application installed on the electronic device as a specialized employee referral application for execution on the electronic device that allows the employee to provide the authorization; and
for each of the multiple employees, prompting the employee to download the specialized employee referral application.

3. The method of claim 2, the method further comprising:
for each of the multiple employees, installing the specialized employee referral application on the electronic device of the employee.

4. The method of claim 3, wherein the electronic device is a mobile device.

5. The method of claim 1, wherein the application is a web browser accessing an employee referral web page, the method further comprising:
for each of the multiple employees, receiving the authorization from the employee upon the employee accessing the employee referral web page.

6. The method of claim 5, wherein the web page is a Hypertext Markup Language version 5 (HTML5) page.

7. The method of claim 5, wherein the electronic device is a mobile device, the method further comprising:
repeating the elements of claim 1 for multiple employees.

8. The method of claim 1, wherein, for each of the multiple employees, forming connections between each authorized connection of each online social network account of the employee and the company online social network account comprises forming first level connections within the online social network between each of the at least one online social network account of the employee and the company online social network account, the method further comprising:
for each of the multiple employees, causing a formation of second level connections between the company online social network account and the target online social network accounts connected to the at least one online social network account of any employee represented in the employee base.

9. (canceled)

10. The method of claim 1, further comprising:
receiving the requirements via the search tool of the recruiter interface; and
performing the search by interacting with application program interfaces (APIs) of the online social network.

11. The method of claim 1, further comprising:
displaying a list of employees who are connected to the job candidate in the online social network; and
receiving a selection of at least one employee from the list of employees from the recruiter.

12. The method of claim 11, wherein the electronic message includes a uniform resource locator (URL) to an online job posting, the URL including a unique identifier associated with the at least one employee for tracking a referral bonus.

13-15. (canceled)

16. A non-transitory machine readable medium storing executable instructions, the instructions, when executed by one or more processors, cause the one or more processors to:
for each of multiple employees of a company, receive an authorization from the employee via an application installed on an electronic device authorizing an employee-authorized online social network connection to be made in an online social network between at least one online social network account of the employee and a company online social network account registered to the company, wherein the company online social network account is owned, hosted, and controlled by a third-party and accessible via the Internet, and wherein the at least one online social network account of the employee and the company online social network account are accounts with the online social network;
cause, within the online social network, a formation of the employee-authorized online social network connections between the at least one online social network account of each of the multiple employees and the company online social network account;
provide a recruiter interface, distinct from a company interface used by the company to access the company online social network account, to enable an electronic device of a recruiter external to the company to use the company online social network account as a proxy to remotely access the at least one online social network account of each of the multiple employees;
receive, from the electronic device of the recruiter using access made available to the company online social network account via the recruiter interface, filtering criteria corresponding to one or more categories of employee attributes of the multiple employees;
define, according to the filtering criteria received from the electronic device of the recruiter via the recruiter interface, an employee base representing a sub-group of the multiple employees identified by searching through the at least one online social network account of each of the multiple employees based on similarities across the one or more categories;
receive, from the electronic device of the recruiter using the access made available to the company online social network account via the recruiter interface, requirements for a job and instructions to perform an automated search, using a search tool available via the recruiter interface, within the online social network for accounts of persons having target online social network accounts connected to the at least one online social network account of any employee represented in the employee base;
perform, according to the instructions received from the electronic device of the recruiter via the recruiter interface, the automated search, with a search tool of the electronic device of the recruiter and based on the requirements for the job, utilizing access to the target online social network accounts via the employee-authorized online social network online social network connections to determine from amongst the target online social network accounts, a list of job candidates meeting the requirements for the job;
receive, from the electronic device of the recruiter, a selection of a job candidate from the list of job candidates for the job;
in response to the selection, determine one or more employees represented in the employee base whose at least one online social network account is connected to the target online social network account of the job candidate; and
send, on behalf of the recruiter, an electronic message to the one or more employees, the electronic message soliciting and including a mechanism to allow each of the one or more employees to refer the job to the job candidate.

17. The non-transitory machine readable medium of claim 16, wherein the instructions, when executed by the one or more processors, cause the one or more processors to:
receive the requirements via the search tool; and
perform the search by interacting with application program interfaces (APIs) of the online social network.

18. The non-transitory machine readable medium of claim 16, wherein the instructions, when executed by the one or more processors, are operable to:
display a list that includes the job candidate to the recruiter; and
receive a selection of the job candidate from the recruiter.

19. The non-transitory machine readable medium of claim 16, wherein the instructions, when executed by the one or more processors, are operable to:
display a list of the employees who are connected to the job candidate in the online social network; and
receive a selection of at least one employee from the list of employees from the recruiter.

20. The non-transitory machine readable medium of claim 19, wherein the instructions, when executed by the one or more processors, are operable to:
include a uniform resource locator (URL) to an online job posting in the electronic message, the URL including a unique identifier associated with the at least one employee for tracking a referral bonus.

21. The method of claim 11 wherein the recruiter is distinct from the employee base.

22. A system, comprising:
one or more processors; and
one or more memories configured to store instructions executable by the one or more processors to:
for each of multiple employees of a company, cause a connection, within an online social network operated by a third party external to the company, of an online social network account of the employee and a company online social network account of the company based on an authorization for the connection received via an application installed on an electronic device of the employee, wherein the online social network account and the company online social network account are accounts within the online social network;
receive, from an electronic device of a recruiter external to the company via a recruiter interface of the online social network distinct from a company interface used by the company to access the company online social network account, filtering criteria corresponding to one or more categories of employee attributes of the multiple employees, wherein the recruiter interface enables the electronic device of the recruiter to, based on the connections between the online social network accounts of the multiple employees and the company online social network account, use the company online social network account as a proxy to remotely access the online social network accounts of the multiple employees;
define, according to the filtering criteria, an employee base representing a sub-group of the multiple employees identified by searching through the online social network accounts of the multiple employees based on similarities across the one or more categories;
receive, from the electronic device of the recruiter via the recruiter interface, requirements for a job and instructions to perform an automated search within the online social network for accounts of persons having target online social network accounts connected to the online social network account of any employee represented in the employee base;
perform, according to the instructions to perform the automated search, the automated search utilizing access to the target online social network accounts via the access made available via the connections between the company online social network account and the online social network accounts of the employees represented in the employee base to determine, from amongst the target online social network accounts, a list of job candidates meeting the requirements for the job;
determine, based on a selection of a job candidate from the list of job candidates received from the electronic device of the recruiter, one or more employees represented in the employee base whose online social network account is connected to the target online social network account of the job candidate; and
send an electronic message to the one or more employees to request the one or more employees to refer the job to the job candidate.

23. The system of claim 22, wherein the application is a specialized employee referral application or a web browser configured to access an employee referral web page.

24. The system of claim 22, wherein the one or more processors are configured to execute the instructions to:
provide the recruiter interface.
